(19) United States
(12) Patent Application Publication
(10) Pub. No.: US 2003/0112849 A1
(43) Pub. Date: Jun. 19, 2003

(54) Efficient quadrature code position modulation

(76) Inventors: Paul Edward Gorday, West Palm Beach, FL (US); Edgar Herbert Callaway JR., Boca Raton, FL (US); Geetha Benamanahalli Nagaraj, Coral Springs, FL (US)

Correspondence Address: Andrew S. Fuller, Motorola, Inc., Law Department, 8000 West Sunrise Boulevard, Fort Lauderdale, FL, 33322, US

(21) Appl. No.: 10/022,943

(22) Filed: Dec. 18, 2001

(51) Int. Cl. H04B 1/69

(52) U.S. Cl. 375/130; 375/239

(57) ABSTRACT

A technique and apparatus for implementing code position modulation (CPM) on in-phase and quadrature-phase components of a radio frequency (RF) carrier. The technique simplifies the modulation/demodulation process by requiring only one pseudo-noise (PN) sequence to be stored in the transceiver device. As a consequence, only a single unique PN sequence needs to be stored in the transceiver, thus resulting in a reduction of circuit complexity.

### TECHNICAL FIELD

This invention relates to techniques and apparatus for data communication and in particular to efficient implementation of Quadrature Code Position Modulation (CPM) for wireless personal area networks.

### BACKGROUND OF THE INVENTION

Due to its use of orthogonal signaling, which enables successful reception at low received signal levels, and Direct Sequence Spread Spectrum (DSSS), which enables low cost implementations, Code Position Modulation (CPM) is a promising modulation method for low cost, low power radio systems. For example, a type of CPM has recently been selected as the modulation format for the IEEE 802.15.4 standard for low-rate wireless personal area networks (WPANs), for which size, cost, and power consumption of devices are critical parameters. Since the practicality of devices employing CPM is often determined by their implementation cost, there is a need for simplified modulation/demodulation techniques that result in lower implementation cost.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram of a quadrature code position modulation system of the prior art.

FIG. 2 is a block diagram of a quadrature code position demodulation system of the prior art.

FIG. 3 is a block diagram of an embodiment of the quadrature code position modulation system of the present invention.

FIG. 4 is a block diagram of an embodiment of the quadrature code position demodulation system of the present invention.

FIG. 5 is a block diagram of an embodiment of a quadrature correlation system of the present invention.

FIG. 6 is a further block diagram of an embodiment of a quadrature correlation system of the present invention.

FIG. 7 is a block diagram of an embodiment of a quadrature modulator of the present invention.

FIG. 8 is a flow chart of a method of quadrature modulation in accordance with an embodiment of the present invention.

FIG. 9 is a flow chart of a method of quadrature demodulation in accordance with an embodiment of the present invention.

FIG. 10 is a block diagram of a further embodiment of a quadrature modulator of the present invention.

FIG. 11 is a block diagram of a further embodiment of a quadrature correlator of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

In quadrature code-position modulation (CPM), each transmitted symbol is represented by a M-chip pseudo-noise (PN) sequence. k bits of information can be encoded into each symbol by circularly shifting the M-chip sequence to one of N=2^{k} positions (where 2^{k} is less than or equal to M).

The present invention is a new technique and apparatus for implementing CPM on in-phase and quadrature-phase components of a radio frequency (RF) carrier. The technique simplifies the modulation/demodulation process by requiring only one pseudo-noise (PN) sequence to be stored in the transceiver device, thus resulting in a reduction of circuit complexity.

If a quadrature type of modulation (e.g., QPSK, OQPSK, MSK, etc.) is used to send the chips (or code bits) in CPM, then it is possible to double the throughput by using independent CPM on the in-phase (I) and quadrature-phase (Q) components of the RF carrier. Furthermore, if coherent demodulation techniques are used, then only one basic PN sequence is needed to represent symbols for both I and Q channels. In other words, phase coherence allows the I and Q channels to be separated in the receiver, and the common PN sequence is used as a reference for determining which symbol (code position) is sent. Unfortunately, obtaining phase coherence adds cost and complexity to the receiver and will likely be avoided by low-cost, low-power applications most likely to employ CPM.

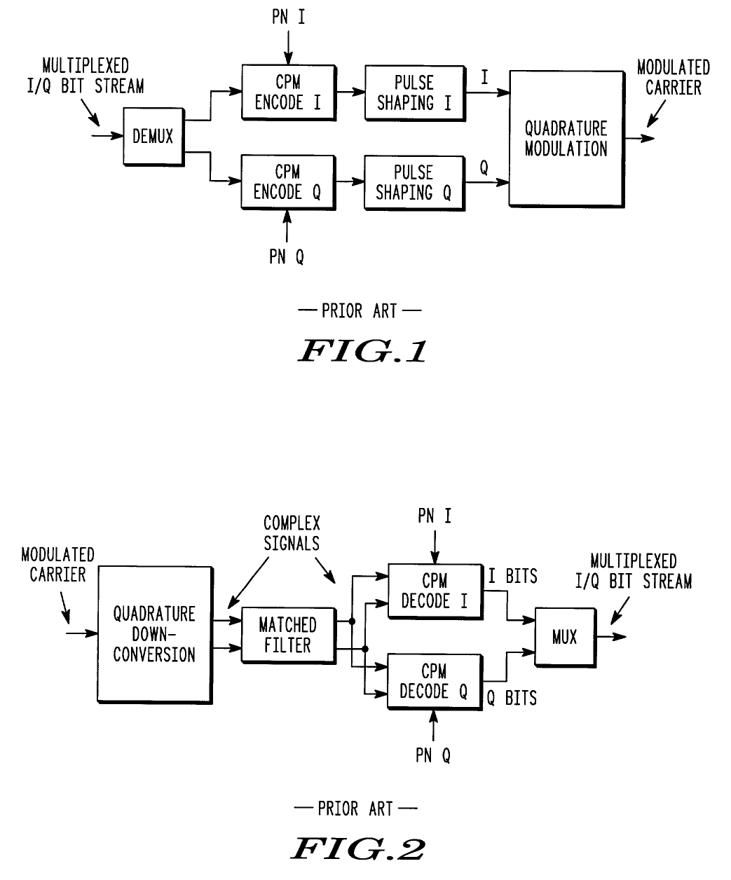

Non-coherent demodulation of quadrature CPM is simpler to implement but prior systems require two separate PN sequences—one for the I-channel and one for the Q-channel. Since the received signal has unknown phase, the receiver can only distinguish I symbols from Q symbols if they are phase shifted versions of two orthogonal (or nearly orthogonal) PN sequences. FIG. 1 shows a block diagram representation of a non-coherent modulation approach, while FIG. 2 shows a block diagram representation of the corresponding non-coherent demodulation approach.

Referring now to FIG. 1, a quadrature modulation system is illustrated. A multiplexed bit stream is passed through a demultiplexor (DEMUX) to obtain data for the in-phase (I) and quadrature (Q) channels. The I- and Q-channels are encoded separately using CPM encoders. Each CPM encoder utilizes a different pseudo-noise (PN) sequence, labeled as PN I and PN Q. The encoded sequences are converted to a sequence of shaped analog pulses and modulated onto in-phase and quadrature components of a RF carrier signal in a quadrature modulator. The components are then combined to form the modulated carrier signal.

FIG. 2 shows a corresponding demodulator. A quadrature down-converter recovers in-phase and quadrature components of the signal that are represented as complex signals. These complex signals are passed through a matched filter. The CPM decoder then decodes the output from the matched filter to obtain the bit-streams for the I- and Q-channels. The bit-streams are then combined in a multiplexor to recover the original bit-stream.

The type of PN sequence used to represent each symbol is preferably a “maximal-length sequence” or “m-sequence”. m-sequences have good auto-correlation properties, making it easy to distinguish phase shifts (different code positions) of the sequence, and they have reasonably good cross-correlation properties, which allows the nearly orthogonal separation of I and Q channels in the non-coherent receiver. Valid m-sequences always come in pairs; each m-sequence has a reciprocal sequence that is simply the time reverse of the original sequence (ref. Zimmer and Peterson, Digital Communications and Spread Spectrum Systems, 1985). This property can be used in the present invention to reduce the number of distinct PN sequences in the receiver from two to one, thereby simplifying the implementation.

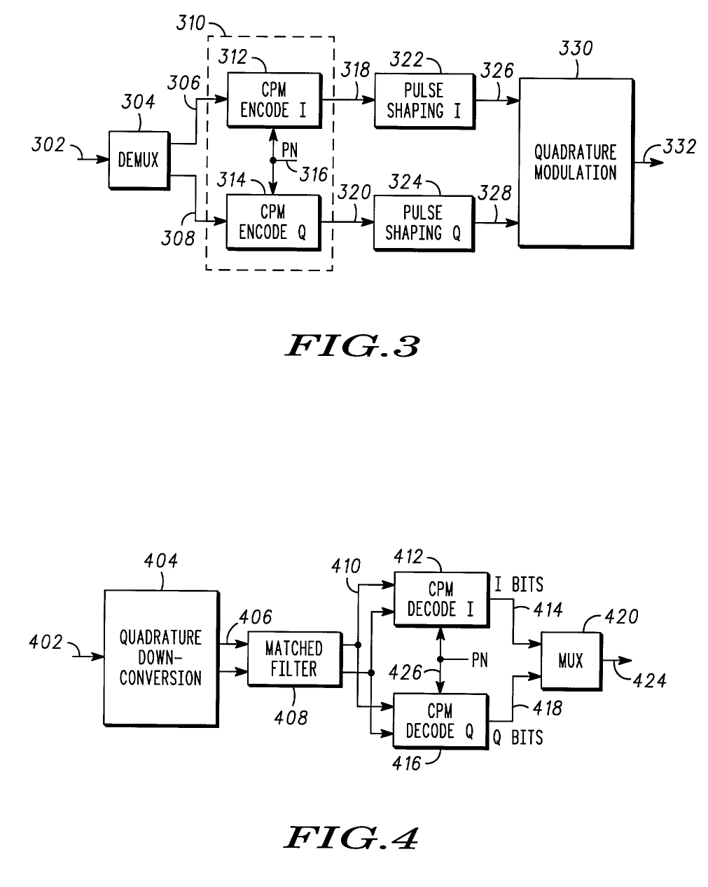

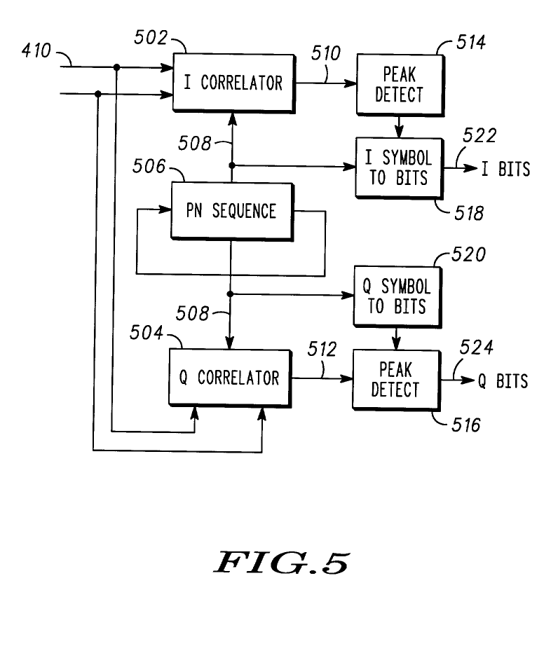

Instead of using two unrelated m-sequences in quadrature CPM, the present invention uses one m-sequence for the I-channel and uses the corresponding reciprocal (or time-reversed) m-sequence for the Q-channel. Both I and Q sequences retain the desired auto-correlation and cross-correlation properties, which allows recovery of I and Q symbols as in FIG. 2. However, now only one distinct sequence needs to be stored in the transceiver. FIGS. 3 and 4 show high-level block diagrams for the new approach, with separate correlators for I and Q demodulation.

Referring now to FIG. 3, a quadrature modulation system of the present invention is illustrated. A multiplexed bit stream 302 is passed through a demultiplexor 304 to obtain data for the in-phase (I) channel data 306 and the quadrature (Q) channel data 308. The channel data generally comprises a sequence of input data symbols. The I- and Q-channels are encoded in quadrature encoder 310, using CPM encoders 312 and 314 respectively. Both CPM encoders utilize the same pseudo-noise (PN) sequence 316. The encoded sequences 318 and 320 are converted by pulse shapers 322 and 324 to sequences of shaped analog pulses 326 and 328. The analog pulses 326 and 328 are modulated onto in-phase and quadrature components of a RF carrier signal in a quadrature modulator 330, and the component signals are combined to produce analog output signal 332.

FIG. 4 shows a corresponding demodulator in accordance with the current invention. A received signal 402 is passed through a quadrature down-converter 404 to recover the in-phase and quadrature components of the signal, which are represented as the complex modulated signal 406. These complex signals are passed through a matched filter 408 to obtain filtered output 410. The CPM decoder 412 decodes the filtered output 410 to obtain the output data symbol and finally the bit-stream 414 for the I-channel. The CPM decoder 416 decodes the filtered output 410 to obtain the output data symbol and finally the bit-stream 418 for the Q-channel. The bit-streams 414 and 418 are then combined in a multiplexor 420 to recover the original bit-stream 424. The decoders 412 and 416 both utilize the same pseudo-noise sequence 426.

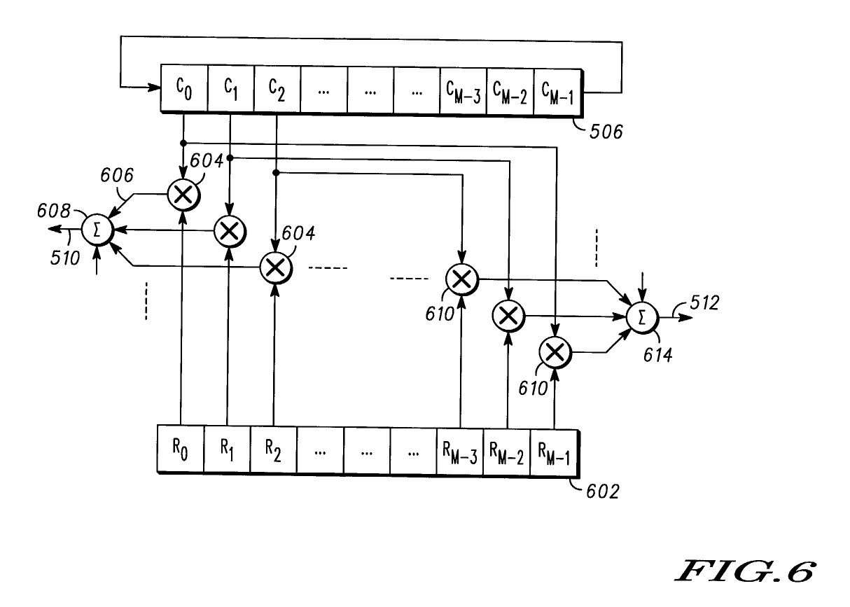

A detailed view of one embodiment of the demodulator is shown in FIG. 5. Referring to FIG. 5, the received (filtered) signal 410 is loaded into complex buffers in the two correlators 502 and 504 in different directions. The signals are then correlated with the pseudo-noise sequence stored in circular buffer 506. This gives the effect of correlating the received signal with the two different PN sequences (the original sequence and the time-reversed sequence). The output 510 from the I-correlator 502 is passed to peak detector 514. The peak detector determines the time delay for which the correlation is maximized; this in turn determines the I-symbol. The I-symbol is converted at 518 to the bit stream 522 for the I-channel. The output 512 from the Q-correlator 504 is passed to peak detector 516. The peak detector 516 determines the time delay for which the correlation is maximized; this in turn determines the Q-symbol. The Q-symbol is converted at 520 to the bit stream 524 for the Q-channel.

FIG. 6 shows one embodiment of a detailed implementation of the I- and Q-correlators and the pseudo-noise buffer. The circular buffer 506 is used to store the pseudo-noise sequence. In this example the pseudo-noise sequence is represented as {C₀, C₁, C₂, . . . , C_{M-1}}. The complex register 602 is used to store the received signal {R₀, R₁, R₂, . . . , R_{M-1}}. Only two registers are needed in the preferred embodiment—one for the received signal and one for the PN sequence. Complex multipliers 604 perform a vector multiplication of the contents of buffer 506 and 602. The multiplied signals 606 and summed in summer 608 to give the I-correlator output 510. The output 510 is given by

$${\sum }_{k = 0}^{M - 1} {C}_{k} {R}_{k} .$$

Similarly, complex multipliers 610 perform a vector multiplication of the time-reversed contents of buffer 506 with the contents of buffer 602. The multiplied signals 612 and summed in summer 614 to give the Q-correlator output 512. The output 512 is given by

$${\sum }_{k = 0}^{M - 1} {C}_{k} {R}_{M - 1 - k} .$$

Compared with the demodulation approach shown in FIG. 2, the approach of the present invention eliminates one set of registers for the other PN sequence along with the circuitry needed to circularly rotate the other PN sequence.

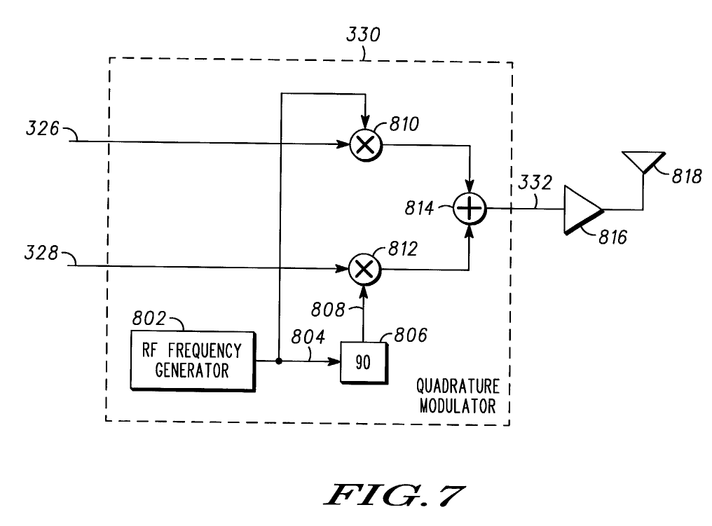

An exemplary quadrature modulator 330 is shown in FIG. 7. A radio frequency (RF) signal generator 802 generates an in-phase RF signal 804 at a specified carrier frequency, fc. The in-phase signal is passed to phase-shifter 806, where it is phase-shifted by 90° to provide quadrature RF signal 808. A sequence of shaped analog pulses 326, corresponding to the I-channel, are supplied to analog multiplier 810 where they are multiplied by the in-phase RF signal 804, thereby modulating the in-phase component of the carrier signal. A sequence of shaped analog pulses 328, corresponding to the Q-channel, are supplied to analog multiplier 812 where they are multiplied by the quadrature RF signal 808, thereby modulating the quadrature component of the carrier signal. The outputs from multipliers 810 and 812 are combined in summer 814 to produce the analog output signal 332. This signal is generally passed through a power amplifier 816 and then to a radio antenna 818.

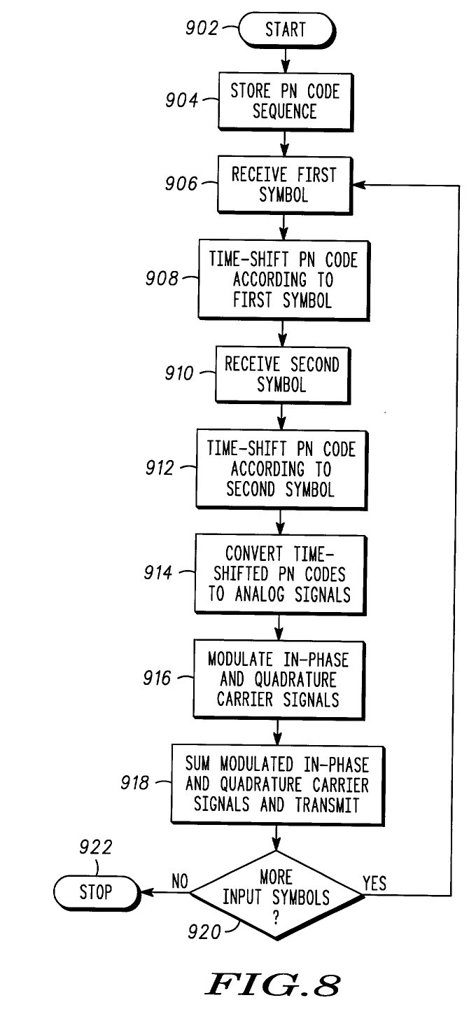

FIG. 8 is a flow chart of a method of quadrature modulation in accordance with an embodiment of the present invention. Referring to FIG. 8, following start block 902, the pseudo-noise code sequence is stored in a memory, such as an M-chip shift register, at block 904. It will be recognized by one skilled in the art that each chip of the M-chips may be represented by one or more samples. A first input symbol is received at block 906. At block 908 the pseudo-noise code sequence is time-shifted by an amount determined by the first input symbol to obtain M chips of an in-phase encoded digital signal. It should be recognized that time-shift and position-shift are equivalent here. A second input symbol is received at block 910. At block 912 the time-reversed pseudo-noise code sequence is time-shifted by an amount determined by the second input symbol to obtain M chips of a quadrature encoded digital signal. At block 914, the in-phase and quadrature encoded digital signals are converted into in-phase and quadrature analog signals, using a pulse shaper. At block 916 the in-phase and quadrature components of a carrier signal are modulated by the in-phase and quadrature analog signals. At block 918, the in-phase and quadrature modulated components of the carrier signal are summed to produce a modulated signal for transmission. At decision block 920, a check is made to determine if more input symbols are to be encoded; if they are, as depicted by the positive branch from decision block 920, flow returns to block 906. If no more symbols are to be encoded, as depicted by the negative branch from decision block 920, the process terminates at block 922.

FIG. 9 is a flow chart of a method of quadrature demodulation in accordance with an embodiment of the present invention. Following start block 952, a pseudo-noise code sequence is stored in a first memory, such as an M-chip shift register, at block 954. An input modulated signal is received at block 956. The pseudo-noise code sequence is then time-shifted and correlated with the input signal at block 958. The time-shifted pseudo-noise code sequence is then reversed and correlated with the input signal at block 960. Equivalently, the input signal could be reversed and correlated with the time-shifted pseudo-noise code sequence. The peaks of these two correlations are updated at block 962. This may comprise comparing the current correlation value to a previous maximum correlation value and updating the maximum correlation value with the current value if the current value is larger. For an M-chip PN code sequence, the correlations are calculated for each of the N time-shift versions of the code sequence, resulting in N correlation values for each of the in-phase and quadrature components. The peak correlation will occur when the time shift is equal to the time-shift applied to the modulation signal before transmission. At decision block 964 a check is made to determine if one or more correlation criteria have been met, where the correlation criteria may be the first correlation value above a threshold, the largest of all possible N-correlation values, or any other desired correlation criteria. If more time-shifts are to be performed, as depicted by the positive branch from decision block 964, flow returns to block 956. If no more time-shifts are to be performed, as depicted by the negative branch from decision block 964, flow continues to block 966 where the time-shifts corresponding to the correlation peaks are converted to in-phase and quadrature symbols. If more input is to be decoded, as depicted by the positive branch from decision block 968, flow returns to block 956. If not, as depicted by the negative branch from decision block 968, the process terminates at block 970.

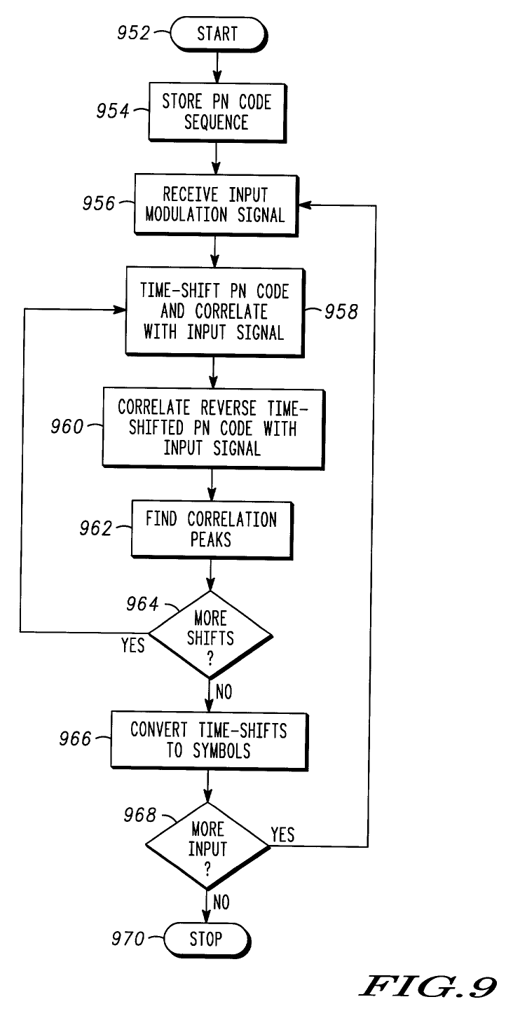

A further embodiment of a quadrature modulator of the present invention is shown in FIG. 10. Referring to FIG. 10, a group of I or Q channel bits 102 is first converted in bit-to-symbol converter 104 to a symbol, and the symbol value 105 determines the shift value applied to the PN sequence. The shifted PN sequence 108 is latched out from shift register 106 to a bi-directional register 110. The operation of the bi-directional register 110 is controlled by selector 112 that provides read direction control signal 114. Depending on whether the bits are associated with the I or Q channel, the selector controls whether the CPM chip sequence is read out of the register 110 in forward or reverse direction, i.e., whether the switch 116 selects the forward PN sequence 118 of the reverse PN sequence 120. The bi-directional read effectively produces the forward or reverse PN sequence. The selected signal is passed to quadrature modulator 122. The benefit of this approach is that a single set of blocks can be time-shared between I and Q channels, thus minimizing hardware. However, the quadrature modulator must have storage space (memory) to hold an I-sequence while waiting for the corresponding Q-sequence since both must be transmitted simultaneously.

FIG. 11 is a block diagram of a further embodiment of a quadrature demodulator. In this embodiment, hardware is reduced, compared to the embodiment shown in FIG. 5, by using only one correlator, one symbol-to-bit converter, and one peak detector. This single “demodulator” is then time shared between I and Q channels. Referring to FIG. 11, in order to demodulate the I-channel, the complex received signal 410 is loaded into the register 530 in the forward direction (left to right), and to demodulate the Q-channel, the complex received signal 530 is loaded into the register 530 in the reverse direction (right-to-left). The load direction is controlled by the I/Q selector 532. As in the embodiments described above, the M complex samples from the register 530 are passed to correlator 534 where they are correlated with the M-chip PN code sequence 508 from shift register 506. The resulting correlation value 536 is passed to peak detector 538 that determines the shift value (symbol). The symbol is then converted to a k-bit information value in symbol-to-bit converter 540 to provide the decoded information value 542. Changing the register loading direction using I/Q selector 532 has the effect of correlating the received signal with the forward and reverse versions of the PN sequence.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A transmitter for generating first and second modulation signals in response to first and second input data symbols in a communication system, said transmitter comprising:
a transmitter memory for storing a code sequence;
a first time shifting means for time-shifting said code sequence by a first time-shift, said first time-shift being determined by said first data symbol, said first shifting means being coupled to said transmitter memory and generating a first encoded sequence; and
a second time shifting means for reversing and time-shifting said code sequence by a second time-shift, said second time-shift being determined by said second data symbol, said second shifting means being coupled to said transmitter memory and generating a second encoded sequence.

2. A transmitter in accordance with claim 1, further comprising a quadrature modulator for generating transmitted modulated signal in response to said first and second modulation signals.

3. A transmitter in accordance with claim 1, further comprising:
a radio frequency signal generator for generating a in-phase radio frequency signal;
a phase-shifter coupled to said radio frequency signal generator for phase shifting said in-phase radio frequency signal and producing a quadrature radio frequency signal;
a first multiplier for multiplying said in-phase radio frequency signal and said first modulation signal to produce an in-phase signal component;
a second multiplier for multiplying said quadrature radio frequency signal and said second modulation signal to produce a quadrature signal component; and
a summer for summing said in-phase signal component with said quadrature signal component to produce an output signal.

4. A transmitter in accordance with claim 1 further comprising a means for converting an input bit-stream into a sequence of first and second input data symbols and said receiver further comprises a means for converting said first and second output data symbols into an output chip-stream.

5. A transmitter in accordance with claim 1, wherein said code sequence comprises M-chips, and said transmitter memory comprises an M-chip shift register for time shifting said code sequence.

6. A transmitter in accordance with claim 1, further comprising first and second pulse shapers for converting said first and second encoded sequences into said first and second modulation signals.

7. A receiver for decoding a complex modulated signal, said receiver comprising:
a receiver memory for storing a code sequence;
a first correlator coupled to said receiver memory for determining the correlation between a time-shifted version of said code sequence and said complex modulated signal; and
a second correlator coupled to said receiver memory for determining the correlation between a time-shifted and time-reversed version of said code sequence and said complex modulated signal.

8. A receiver in accordance with claim 7, said receiver further comprising:
an M-chip shift register for storing and time-shifting an M-chip code sequence;
an M-chip complex register for storing said complex modulated signal.
a first multiplier means for multiplying the code sequence stored in the M-chip shift register by the complex modulated signal stored in the M-chip complex register to generate first multiplier outputs;
a first summer for summing the first multiplier outputs to produce a first correlation signal;
a second multiplier means for multiplying the reverse of the code sequence stored in the M-chip shift register by the complex modulated signal stored in the M-chip complex register to generate second multiplier outputs; and
a second summer for summing the second multiplier outputs to produce a second correlation signal.

9. A receiver in accordance with claim 7, further comprising:
a first peak detector for detecting a peak in said first correlation signal;
means responsive to said first peak detector and said receiver memory for recovering said first output data symbol;
a second peak detector for detecting a peak in said second correlation signal; and
means responsive to said second peak detector and said receiver memory for recovering said second output data symbol.

10. A receiver in accordance with claim 7, further comprising a quadrature down-converter for converting a received modulated signal into said complex modulated signal.

11. A communication system, comprising:
a transmitter for generating first and second modulation signals in response to first and second input data symbols, said transmitter comprising:
a transmitter memory for storing a code sequence;
a first time shifting means for time-shifting said code sequence by a first time-shift, said first time-shift being determined by said first data symbol, said first shifting means being coupled to said transmitter memory and generating a first encoded sequence; and
a second time shifting means for reversing and time-shifting said code sequence by a second time-shift, said second time-shift being determined by said second data symbol, said second shifting means being coupled to said transmitter memory and generating a second encoded sequence;
a receiver for decoding a complex modulated signal, said receiver comprising:
a receiver memory for storing a code sequence;
a first correlator coupled to said receiver memory for determining the correlation between a time-shifted version of said code sequence and said complex modulated signal; and
a second correlator coupled to said receiver memory for determining the correlation between a time-shifted and time-reversed version of said code sequence and said complex modulated signal.

12. A communication transmitter for generating first and second modulation signals in response to first and second input data symbols, said transmitter comprising:
a transmitter memory for storing a code sequence;
a time-shifting means for time-shifting said code sequence by a time-shift, said time-shift being determined by said first or second data symbol, said shifting means being coupled to said transmitter memory and generating an encoded sequence corresponding to said first or second data symbol;
a bi-directional register operable to store said encoded sequence, said bi-directional register having first and second read directions; and
a selector operable to select said first or second read directions according to whether said encoded sequence corresponds to said first or second data symbol;
wherein said first modulation signal is generated when said first read direction is selected and said second modulation signal is generated when said second read direction is selected.

13. A receiver for decoding a complex modulation signal in a communication receiver to recover a data value, said receiver comprising:
an M-chip shift register for storing and time shifting an M-chip code sequence;
a bi-directional register operable to store said complex modulation sequence, said bi-directional register having first and second write directions;
a selector coupled to said bi-directional register and operable to select between said first and second write directions;
a correlator coupled to said bi-directional register and said M-chip shift register and operable to correlate said complex modulation signal with said M-chip code sequence to produce a correlation signal;
a peak detector for detecting a peak in said correlation signal; and
means responsive to said peak detector and said M-chip shift register for recovering said data value.

14. A method for encoding first and second input data symbols, each input data symbol having one of N values, said method comprising:
storing a pseudo-noise code sequence in a memory;
time-shifting said pseudo-noise code sequence by an amount determined by the first input symbol to obtain M chips of an in-phase encoded digital signal; and
time-shifting the time-reversal of said pseudo-noise code sequence by an amount determined by the second input symbol to obtain M chips of a quadrature encoded digital signal;

15. A method in accordance with claim 14, further comprising:
converting said in-phase and quadrature encoded digital signals into in-phase and quadrature signals; and
modulating an in-phase component of a carrier signal by said in-phase signal;
modulating a quadrature component of a carrier signal by said quadrature signal; and
summing said in-phase and quadrature components of the carrier signal to produce a modulated signal.

16. A method in accordance with claim 14, further comprising converting an input bit-stream into said first and second input data symbols.

17. A method for decoding a complex code position modulated signal, said signal representing in-phase and quadrature encoded symbols, said method comprising:
storing a pseudo-noise code sequence in a memory;
generating time-shifted versions of said pseudo-noise code sequence;
determining a first correlation between the time-shifted versions of the pseudo-noise code sequence and the complex code position modulated signal;
determining the time shift that satisfies a first predetermined correlation criteria, thereby decoding said in-phase encoded symbol;
determining a second correlation between the time-shifted versions of the time reversal of the pseudo-noise code sequence and the complex code position modulated signal; and
determining the time shift that satisfies a second predetermined correlation criteria, thereby decoding said quadrature encoded symbol.

18. A method in accordance with claim 17, wherein said memory is an M-chip shift register and wherein determining a first correlation comprises:
storing said complex code position modulated signal in a second memory; and for each of N clock cycles:
performing a vector multiplication of the contents of said first memory with the contents of said second memory to obtain M first products;
adding the M first products to determine the first correlation; and
causing a circular shift of the contents of the M-chip shift register by one or more chips.

19. A method in accordance with claim 17, wherein said memory is an M-chip shift register and wherein determining a second correlation comprises:
storing said complex code position modulated signal in a second memory; and for each of N clock cycles:
performing a vector multiplication of the contents of said first memory with the time-reversal of the contents of said second memory to obtain M second products;
adding the M second products to determine the second correlation; and
causing a circular shift of the contents of the M-chip shift register by one or more chips.

20. A method in accordance with claim 17, wherein said complex code position modulated signal is generated by:
receiving a modulated signal; and
down-converting said modulated signal in a quadrature down-converter to obtain an in-phase component and a quadrature component, said an in-phase component and a quadrature components representing the real and imaginary parts, respectively, of said complex code position modulated signal.

21. A method in accordance with claim 20, further comprising passing said complex code position modulated signal through a matched filter.
